(19) United States
(12) Patent Application Publication
(10) Pub. No.: US 2013/0346439 A1
(43) Pub. Date: Dec. 26, 2013

(54) Pushing Business Objects

(71) Applicant: Alibaba Group Holding Limited, Grand Cayman (KY)

(72) Inventors: Bing Wang, Hangzhou (CN); Tong Liu, Hangzhou (CN)

(21) Appl. No.: 13/926,806

(22) Filed: Jun. 25, 2013

(30) Foreign Application Priority Data
Jun. 26, 2012 (CN) 201210216267.5

(51) Int. Cl. G06F 17/30

(52) U.S. Cl. CPC G06F 17/30424
USPC 707/769

(57) ABSTRACT

The present disclosure provides example methods and apparatuses for pushing business objects. The server receives a business operation request from a terminal. The business operation request includes an object identification of a business object published or provided at a website. A business object category of the business object corresponding to the object identification is determined. Business objects that are the same but published by different business object providing units belong to a same business object category. According to a corresponding relationship list between business object categories and correlated business object categories, a correlated business object category corresponding to the determined business object category is searched. A business object is selected from the searched correlated business object category and pushed to the terminal. The present techniques improve processing efficiencies of pushing the business object.

### CROSS REFERENCE TO RELATED PATENT APPLICATIONS

This application claims foreign priority to Chinese Patent Application No. 201210216267.5 filed on 26 Jun. 2012, entitled “Method and Apparatus for Pushing Business Objects,” which is hereby incorporated by reference in its entirety.

### TECHNICAL FIELD

The present disclosure relates to the field of network technology, and more specifically, to a method and apparatus for pushing business objects.

### BACKGROUND

With the fast development of network technology, more and more businesses are conducted and operated through a network. For example, a terminal supporting a network communication may visit a website to access business provided by the website. In actual applications, each website publishes its provided businesses to the network mainly through its server, and the server processes a corresponding business according to data submitted by the terminal. FIG. 1 shows a flowchart of an example process that the server employs for conducting the business. As shown in FIG. 1, the operations that the server employs for conducting its business mainly include the following steps.

At 102, the server receives a business operation request from the terminal that includes a first object identification of a first business object. The first object identification may be carried in the business operation request sent from the terminal to the server so that the server may determine the business object that the terminal requests for an operation.

At 104, the server, according to the first object identification, determines whether there exists a second object identification of a correlated business object corresponding to the first object identification. If there exists, operations at 106 are performed; otherwise, the process terminates.

At 104, there might be multiple identifications of correlated business objects corresponding to the first object identification. That is, there might be multiple business objects correlated with the first business object. A second business object that is correlated to the first business object is used as an example here. The business object correlated with the first business object is a business object, which is operated by a terminal with the designated operation simultaneously when the first business object is operated by the terminal. In the actual applications, identifications of business objects correlated to the first business object are generally pre-determined. Specifically, the server, according to its own records that multiple business objects are operated by the same terminal with the designated operation, determines the business objects that are simultaneously operated by the same terminal with the designated operation as the correlated business objects.

For example, in a latest record of the server, a number of times that the first business object is operated by the terminal with the designated operation represents 20% of a number of times that all business objects in the server that are operated by the terminal with the designated operation. The multiple business objects related to the first business object may include the second business object and a third business object. A number of times that the first business object and the second business object are operated by the same terminal simultaneously may represent 80% of the number of times that the first business object is operated by the terminal with the designated operations. A number of times that the first business object and the third business object are operated by the same terminal simultaneously may represent 40% of the number of times that the first business object is operated by the terminal with the designated operations. The server then determines that the second business object is correlated with the first business object. For example, the number 20% herein may be referred to as a degree of support between the first business object and its related business objects. The numbers 40% and 80% herein may be referred to as a degree of confidence between the first business object and the third business object and a degree of confidence between the first business object and the second business object respectively.

At 106, the server sends an identification of the determined correlated business object to the terminal. The process that the server processes business terminates after 106.

In the flow process as shown in FIG. 1, if a business volume provided by a website is large, the multiple business objects may belong to different business object providing units based on needs. The same business objects may be provided by the multiple business object providing units. However, the server treats the same business objects provided by different business object providing units as different business objects. Furthermore, the server determines that the business object corresponding to the object identification of the correlated business object is provided by a business object providing unit that also provides the business object requested by the terminal. In other words, at 106, the first business object and the second business object that corresponds to the identification of the correlated business object sent by the server belong to the same business object providing unit.

In the actual application, the above process may be applicable in an e-commerce business platform. For example, different shops providing various products at the website may correspond to different business object providing units at the website. The products provided by the shops to the terminal may correspond to the business objects provided by the business object providing units. In addition, the designated operation conducted by the terminal to the business object may correspond to an operation conducted by the terminal to purchase the product, an operations conducted by the terminal to save the product, etc. The designated operation may be defined according to actual scenarios.

Alternatively, the business providing units included by the website may be set as different subject forums corresponding to different subjects at the website, such as a laptop forum, a digital camera forum. The business objects provided by the business object providing units may be information corresponding to posts at the different subject forums such as information that a registered terminal user provided for a specific topic.

According to the flow process as shown in FIG. 1, with respect to the website that has a large business volume, even if the business objects belong to different business object providing units, the server, according to the first business object provided by a current business object providing unit, determines correlated business objects of the first business object from the current business object providing unit. In the actual applications, after the server determines and pushes the correlated business object from the current business object providing unit, as the correlated business objects may be canceled or temporarily unable at the current business object providing unit, the terminal may be unable to present the correlated business object. In other words, the server fails to push the business object, thereby wasting processing resources of the server. Furthermore, when determining the correlated business object of a specific business object, the server may treat the same business objects provide by different business object providing units as different business objects. Thus, the server needs to process a large data volume of the correlated business objects, spends a long calculation time, and has a low processing efficiency.

Accordingly, the conventional techniques waste resources and have low processing efficiency during the process that the server pushes the business object.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method and an apparatus for pushing business objects to reduce consumption of processing resources and improve processing efficiencies.

The present disclosure provides an example method for pushing business objects. The server receives a business operation request from a terminal. The business operation request includes an object identification of a business object published or provided at a website. A business object category of the business object corresponding to the object identification is determined Business objects that are the same but published by different business object providing units belong to a same business object category. According to a corresponding relationship list between business object categories and correlated business object categories, a correlated business object category corresponding to the determined business object category is searched. The correlated business object category is a business object category satisfying one or more correlation conditions with the determined business object category. A business object is selected from the searched correlated business object category and pushed to the terminal.

The present disclosure also provides an example apparatus for pushing business objects. The apparatus may include an operation request receiving unit, a business object category determining unit, a correlated business object category searching unit, and a business object pushing unit. The operation request receiving unit receives a business operation request from a terminal. The business operation request includes an object identification of a business object published at a website. The business object category determining unit determines a business object category of the business object corresponding to the object identification. Business objects that are the same but published by different business object providing units belong to a same business object category. The correlated business category searching unit searches, from a corresponding relationship list between business object categories and correlated business object categories, a correlated business object category corresponding to the determined business object category. The correlated business object category is a business object category satisfying one or more correlation conditions with the determined business object category. The business object pushing unit selects a business object from the searched correlated business object category and pushes the business object to the terminal.

According to the present techniques, the server receives the business operation request from the terminal. The business operation request includes the object identification of the business object published at the website. The server then determines the business object category of the business object corresponding to the object identification and searches, from the corresponding relationship list between business object categories and correlated business object categories, the correlated business object category corresponding to the determined business object category. The server also selects a business object from the searched correlated business object category and pushes it to the terminal. Business objects that are the same but published by different business object providing units belong to the same business object category. The correlated business object category is a business object category satisfying one or more correlation conditions with the determined business object category.

According to the present techniques, the server, based on correlations between business object categories, determines the business object category of the business object corresponding to the object identification included in the business operation request of the terminal, searches the correlated business object category corresponding to the determined business object category, and selects the business object from the searched correlated business category and pushes the business objet to the terminal. Under the conventional techniques, the server determines and pushes the correlated business object from the same business object providing unit (which provides the determined business object), which may lead to a high failure rate of the terminal to present the correlated business object. Under the present techniques, as the same business objects published by different business object providing units at the website belong to the same business object category, the business object selected by the server may be the business object selected from the correlate business object category and may include the business object at different business object providing units, thereby reducing the failure of the terminal to present the correlate business object and reducing the waste of processing resources. In addition, the correlated business object may be determined based on the business object category that the business object belongs instead of the business object, thereby reducing data volume processed by the server and calculation volume for pushing the business object. Thus, the processing efficiencies for pushing the business object are also improved.

The other characteristics and advantages of the present techniques may be described below in the present disclosure, become obvious as shown from the present disclosure, or be known from implementation of the present disclosure. Purposes and advantages of the present techniques may be implemented or obtained through the specification, claims, and diagrams in the FIGs.

### BRIEF DESCRIPTION OF THE DRAWINGS

To better illustrate embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts.

FIG. 1 illustrates a flow chart of a method that a server processes business under conventional techniques.

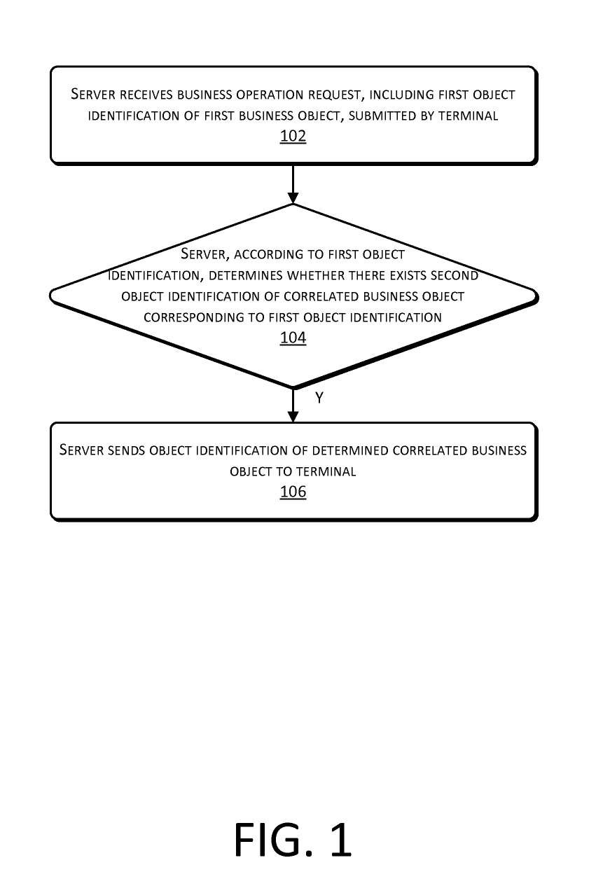

FIG. 2 illustrates a flow chart of an example method for pushing a business object in accordance with a first example embodiment of the present disclosure.

FIG. 3 illustrates a flow chart of an example method that a server pre-determines a correlated business object category of a business object category in accordance with the first example embodiment of the present disclosure.

FIG. 4 illustrates a flow chart of an example method that the server pushes the business object to the terminal in accordance with the first example embodiment of the present disclosure.

FIG. 5 illustrates a flow chart of an example method for determining the correlated business object category in accordance with the first example embodiment of the present disclosure.

FIG. 6 illustrates a flow chart of an example method for recommending a product in accordance with a second example embodiment of the present disclosure.

FIG. 7 illustrates a diagram of a first example apparatus for pushing the business object in accordance with a third example embodiment of the present disclosure.

FIG. 8 illustrates a diagram of a second example apparatus for pushing the business object in accordance with the third example embodiment of the present disclosure.

FIG. 9 illustrates a diagram of a third example apparatus for pushing the business object in accordance with the third example embodiment of the present disclosure.

### DETAILED DESCRIPTION

The present disclosure provides an example method and apparatus for pushing business objects, which reduce consumption of processing resources and improve processing efficiencies when pushing the business objects. The following descriptions are described by reference to the FIGs and some example embodiments. The example embodiments herein are solely used to illustrate the present disclosure and shall not be used to limit the present disclosure. The example embodiments or features of the example embodiments may be combined or referenced to each other when there is no conflict.

A first example embodiment of the present disclosure provides an example method for pushing business objects. The example method may be applicable at an e-commerce platform. When the present techniques are applied at the e-commerce platform, a failure of a terminal to present a pushed business object is reduced and data volume processed by a server is reduced. Thus, the present techniques reduce a consumption of processing resources and improve a processing efficiency of pushing the business object.

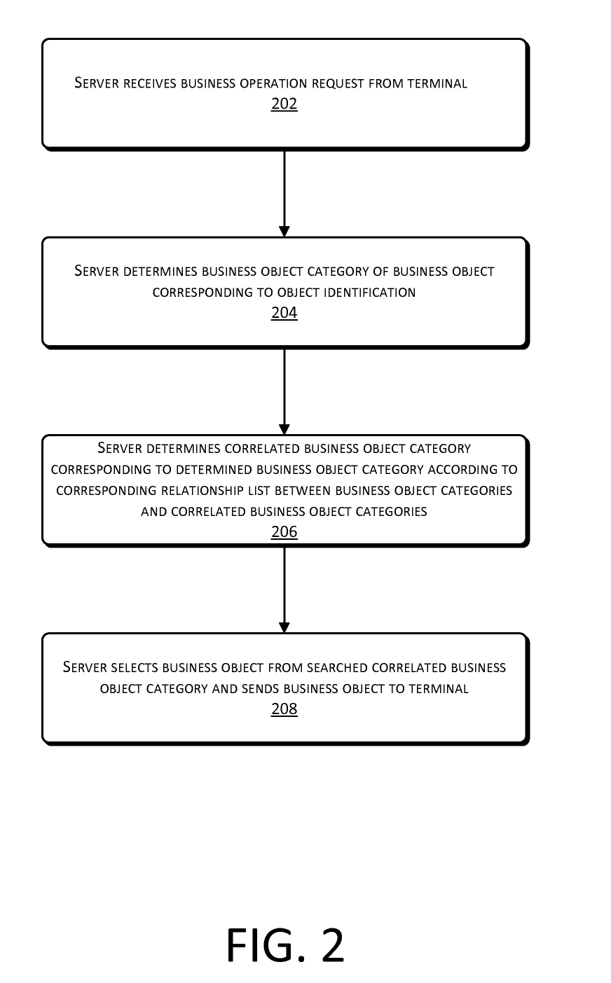

FIG. 2 illustrates a flow chart of the first example method for pushing the business object.

At 202, the server receives a business operation request from the terminal. The business operation request may include an object identification of a business object published at a website. In other words, the object identification is an identification corresponding to the business object that the terminal requests to operate. In addition, in actual applications, the business operation request may include not only the object identification but also information relating to an operation of the terminal and the business object that the terminal requests to operate. The information may be defined according to actual needs in the actual applications.

At 204, the server determines a business object category of the business object corresponding to the object identification.

A set of the business objects that are same but published by different business object providing units of the website may be referred to as one business object category. In other words, the same business objects published by different business object providing units of the website belong to the same business object category. In addition, the server may, according to the actual scenarios, classify the business objects into multiple business object categories. Each business object category corresponds to a different classification.

For example, a first business object may belong to a first business object category with a lowest level. Business objects included in the first business category may also belong to a second business object category. Thus, the first business object category may also belong to the second business object category and a level of the second business category is higher than that of the first business category. Further, the second business object category may also include one or more other business object categories that have a same level as the first business object category. The second business object may also belong to another business object category with a higher level than the second business object category. Details are not described herein for the purpose of brevity. In the actual applications, the business object category of the business object corresponding to the object identification included in the business operation request, which is determined by the server, may be the business object category with the lowest level among different business object categories that the business object belongs. Alternatively, according to a business characteristic or any other actual scenario, a business object category with some other level may be chosen. In this example embodiment, the present techniques choose the business category with the lowest level as an example.

At 206, the server, from a corresponding relationship list between one or more business object categories and correlated business object categories, searches one or more correlated business object categories that correspond to the determined business object category.

The corresponding relationship list may be a list that is pre-established by the server to store corresponding relationships between the business object categories and the correlated business object categories. The correlated business object category is a business object category that satisfies one or more correlated conditions with the determined business object category. The one or more correlated conditions may be set according to a business attribute or a need. For example, according to a number of times that business objects in different business object categories are operated by the same terminal with a designated operation simultaneously or within a preset period of time, business object categories whose number of times meet a preset number of times are determined as correlated business object categories. That is, the business object categories whose degrees of confidence satisfy the preset conditions are determined as the correlated business object categories of the determined business object category. In addition, the server may determine one or multiple correlated business object categories.

At 208, the server selects a business object from the searched correlated business object categories and pushes the business object to the terminal.

When the server selects the business object from the searched correlated business object categories, the server may select the business object to be pushed to the terminal according to one or more preset conditions or a need of the terminal that presents the business object. For example, the server may select a business object that has received a satisfying number of times of operations from the terminal from the searched correlated business object categories and push the business object to the terminal. Alternatively, the server may select a business object whose business characteristic is most similar to a business requested for operation by the terminal from the searched correlated business object categories and push the business object to the terminal. Alternatively, the server may select a business category that is most recently added into the searched correlated business categories from the searched correlated business categories and push the business object to the terminal. In the actual applications, the server may, according to the actual scenarios and needs, set one or more particular conditions to select the business object from the searched business object categories. Details are not described herein for the purpose of brevity. In addition, one business object category may include the same business objects provided by the different business object providing units at the website. Thus, the business objects selected from the correlated business object categories may belong to different business object providing units.

In the flow process as shown in FIG. 2, the server, based on the correlation between business object categories, determines the business object category of the business object corresponding to the object identification included in the business operation request of the terminal, searches the correlated business object categories corresponding to the determined business object category, and selects the business object from the searched correlated business categories and pushes the business objet to the terminal. Under the conventional techniques, the server determines and pushes the correlated business object from the same business object providing unit (which provides the business object corresponding to the object identification), which may lead to the failure of the terminal to present the correlated business object. Under the present techniques, as the same business objects published by different business object providing units at the website may belong to the same business object category, the business object selected by the server may be the business object selected from the correlate business object category and may include the business object at different business object providing units, which may reduce the failure of the terminal to present the correlate business object and thus reduce the waste of processing resources. In addition, the correlated business object may be determined based on the business object category to whch the business object belongs instead of directly based on the business object under the conventional techniques, thereby reducing data volume processed by the server and calculation volume when pushing the business object. Thus, the processing efficiencies for pushing the business object are also improved.

At 206, the server, from the corresponding relationship list between the business object categories and correlated business object categories, searches the correlated business object category that correspond to the determined business object category. The corresponding relationship list may be the list that is pre-established by the server to store corresponding relationships between the business object categories and the correlated business object categories. For example, the server may update the corresponding relationship list according to one or more preset conditions, such as a time period that the corresponding relationship list shall be updated, or other updating considerations such as a number of times that business objects provided by the server are operated by the terminal with the designated operation. For another example, the techniques updating the corresponding relationship list may be set according to the actual scenarios or business characteristics.

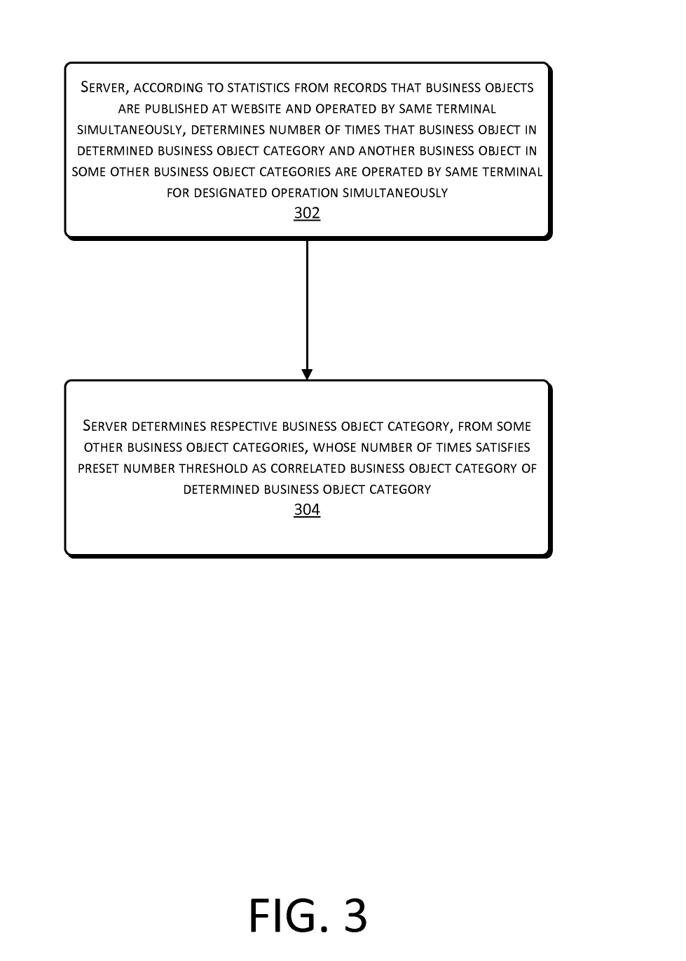

Corresponding to the above descriptions, FIG. 3 illustrates a flow chart of an example method for determining the correlated business object categories of the determined business object category when updating or establishing the corresponding relationship list.

At 302, the server, according to statistics from records of business objects that are published at the website and operated by the same terminal simultaneously or within a preset period of time, determines a number of times that a business object in the determined business object category and another business object in some other business object categories are operated by the same terminal with a designated operation simultaneously or within the preset period of time.

For example, the server, by using the business object category as a unit, calculates a number of times that business objects in different business object categories are operated by the same terminal with the designated operation simultaneously. That is, the server determines a degree of confidence between the determined business object category and another business object category.

At 304, the server determines a respective business object category, from some other business object categories, whose number of times satisfies a preset number threshold as the correlated business object category of the determined business object category.

At 304, it is just an example method that set the one or more business object categories whose number of times satisfying the preset number threshold as the correlated business object categories of the determined business object category. In the actual applications, there may be different methods to determine the correlated business object categories of the determined business object category according to the actual scenarios. The one or more business object categories whose number of times satisfying the preset number threshold may be understood as the one or more business object categories whose degrees of confidence meet a threshold.

In the actual applications, parameters corresponding to the different business object categories may also include a degree of support. Using the determined business object category as an example, the degree of support of the determined business object category is a ratio of a sum that a number of times of business objects in the determined business object category operated by the terminal with the designated operation to a sum that a number of times that different business objects provided by the server and operated by the terminal with the designated operation. Such a ratio does not interfere with the server to determine the correlated business object categories of the determined business object category according to the degree of confidence. Thus, in the actual applications, the degree of confidence may be used as a primary parameter to determine the correlated business object categories of the determined business object category.

In the flow process of FIG. 3, the server uses the business object category that each business object belongs as a unit to determine the correlated business object category. In contrast, the conventional techniques use the business object as the unit to determine the correlated business object. Thus, the present techniques reduce the data volume to determine the correlated business object and improve the processing efficiency of the server to process data.

Before 204 in FIG. 2, i.e., before the server determines the business object category of the business object corresponding to the object identification, in the actual applications, the server may firstly determine whether the business object corresponding to the object identification belongs to a standard business object set. If the business object does not have the standard business object set, the following operations after 204 may be performed. The standard business object set includes one or more business objects that satisfy a designated business object standard of a business object category. The designated business object standard may be determined by the server according to one or more business standards corresponding to the business objects. The business standards generally refer to specifications to conduct a business within an industry that the business belongs. The standard business object set is generally a set with the lowest level among various sets with different levels that a particular business object belongs, such as a standard product unit (SPU) for electronic products that has a designated naming specification and designated function.

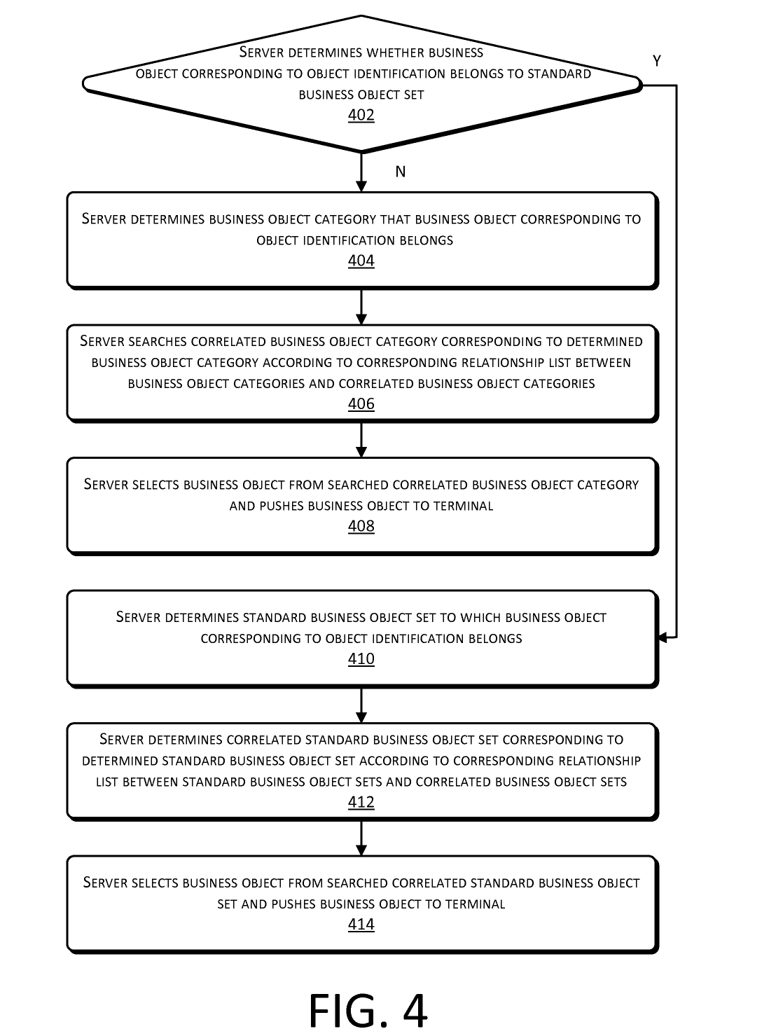

Based on a type of set that the business object corresponding to the object identification (such as the business object category or the standard business object set), FIG. 4 illustrates a flow chart of an example method that the server pushes the business object to the terminal.

At 402, the server determines whether the business object corresponding to the object identification belongs to a standard business object set. If a result is negative, operations at 404 are performed. Otherwise, operations at 410 are performed.

In the actual applications, each standard business object may belong to at least one business object category. The business object category may include one or more standard business object sets that have different business object standards. Such business object category may also belong to another business object category with a higher level. Thus, the standard object category set belonging to the business object category may also belong to another business object category with the higher level to which the business object category belongs.

At 404, the server determines the business object category that the business object corresponding to the object identification belongs.

At 406, the server searches one or more correlated business object categories of the determined business object category from the corresponding relationship list between business object categories and correlated business object categories.

In addition to searching the correlated business object categories of the determined business object category, if there exists the standard business object set that corresponds to the determined business object category, the server may also determine that such standard business object set is the set correlated to the determined business object category.

At 408, the server selects a business object from the searched correlated business object category and pushes the business object to the terminal.

At 410, the server determines the standard business object set that the business object corresponding to the object identification belongs.

At 412, the server, from a corresponding relationship list between standard business object sets and correlated standard business object sets, searches one or more correlated standard business object sets corresponding to the standard business object set.

The correlated standard business object sets are standard business object sets satisfying one or more preset correlation conditions with the determined standard business object set. The corresponding relationship list is a list, pre-established by the server, which stores the corresponding relationship between the standard business object sets and their correlated standard business object sets. In the actual applications, the corresponding relationship between the standard business object sets and the correlated standard business object sets and the corresponding relationship between the business object categories and the correlated business object categories may be stored in the same list, or separate lists. Example methods for determining the corresponding relationship list between the standard business object sets and the correlated standard business object sets and determining the correlated standard business object set corresponding to the designated standard business object set may be described by reference to operations at 206 and FIG. 3, which are not detailed herein. In addition, if the correlated business object category that corresponds to the determined standard business object set exists, such correlated business object category may be determined as a correlated set of the determined standard business object set.

At 414, the server selects a business object from the searched correlated standard business object set and pushes the business object to the terminal. An example method for selecting the business object from the searched correlated standard business object set may be described by reference to operation at 208.

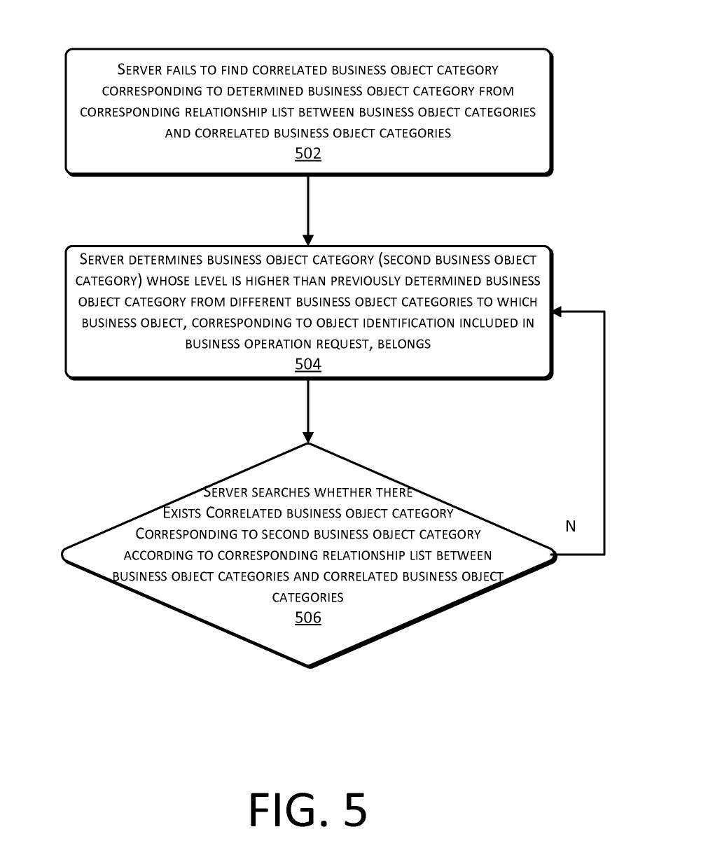

Before operations at 208 of FIG. 2, i.e., before the server selects the business object from the searched correlated business object category, if the server at 206 fails to search the correlated business object category corresponding to the determined business object category from the corresponding relationship list between business object categories and correlated business object categories, i.e., the server fails to find the correlated business object category corresponding to the determined business object category, the server may determine another business object category to which the determined business object category belongs. The server may further search, from the corresponding relationship list between the business object categories and the correlated business object categories, a correlated business object category corresponding to the another business object category to which the determined business object category belongs. Using a first business object category and a second business object category as examples, the present disclosure provides another example method for determining the correlated business object category. FIG. 5 illustrates a flow chart of another example method for determining the correlated business object category in accordance with the first example embodiment of the present disclosure.

At 502, the server does not find a correlated business object category corresponding to the determined business object category (or the first business object category) from the corresponding relationship list between business object categories and correlated business object categories.

At 504, the server determines a business object category whose level is higher than the previously determined business object category from different business object categories to which the business object, corresponding to the object identification included in the business operation request, belongs.

For example, the business object category whose level is higher than the determined business object category is another business object category (or the second business object category) to which the determined business object category belongs. In other words, from various business object categories having different levels to which the business object corresponding to the object identification belongs, the second business object category to which the first business object category belongs is determined. Furthermore, a level of the second business object category is higher than that of the first business object category.

At 506, the server, according to the corresponding relationship list between the business object categories and the correlated business object categories, searches whether there exists a correlated business object category corresponding to the second business object category. If a result is positive, the process terminates. If the result is negative, operations at 504 are continuously performed.

If at 506 the server does not find the correlated business object category corresponding to the second business object category from the corresponding relationship list, the server, when performing operations at 504, determines another business object category that the second business object category belongs and has a level higher than the second business object category from the various business object categories with different levels to which the business object corresponding to the object identification included in the business operation request belongs. Operations at 504 and 506 are performed recursively until the server determines a particular business object category, from the various business object categories with different levels to which the business object corresponding to the object identification included in the business operation request belongs, that has a correlated business object category in accordance with the corresponding relationship list.

The flow process as shown in FIG. 5 may ensure that the determined business object category, which is determined from the various business object categories with different levels to which the business object corresponding to the object identification included in the business operation request belongs, has a corresponding correlated business object category in accordance with the corresponding relationship list. Thus, the present techniques ensure that the server successfully pushes the business object to the terminal, thereby improving the successful rate of pushing the business object to the terminal. In the actual applications, for example, the server may determine that the business object corresponding to the object identification included in the business operation request belongs to the standard business object set, and fail to find the correlated standard business object set corresponding to the standard business object set from the corresponding relationship list between the standard business object sets and the correlated standard business object sets. In other words, the server may further select a business object category with a lowest level from the various business object categories with different levels to which the business object corresponding to the object identification included in the business operation request belongs, and fail to find the correlated business object category corresponding to the business object category with the lowest level. The server may perform the operations as shown in FIG. 5.

A second example embodiment of the present disclosure, corresponding to the first example embodiment of the present disclosure that provides the example method for pushing the business object, provides an example application scenario that applies the techniques for pushing the business object. For example, the business object is pushed through an e-commerce platform. More particularly, in a shopping website, the server recommends a product to the terminal.

The shopping website, no matter whether it provides one type of product or multiple types of products through various shops, may determine a product category or SPU of a particular product according to a product attribute or characteristic of the particular product. In addition, with respect to the shopping website that has multiple shops, products that have the same characteristic or attribute and are provided by different shops may belong to the same product category or SPU. SPU is a smallest set to which the product belongs and each SPU belongs to a product category. In other words, SPU is a set with a lowest level among all sets to which the product belongs. That is, SPU is the product category with the lowest level. In the actual applications, one or more correlated sets are determined for the set with the lowest level that the product belongs.

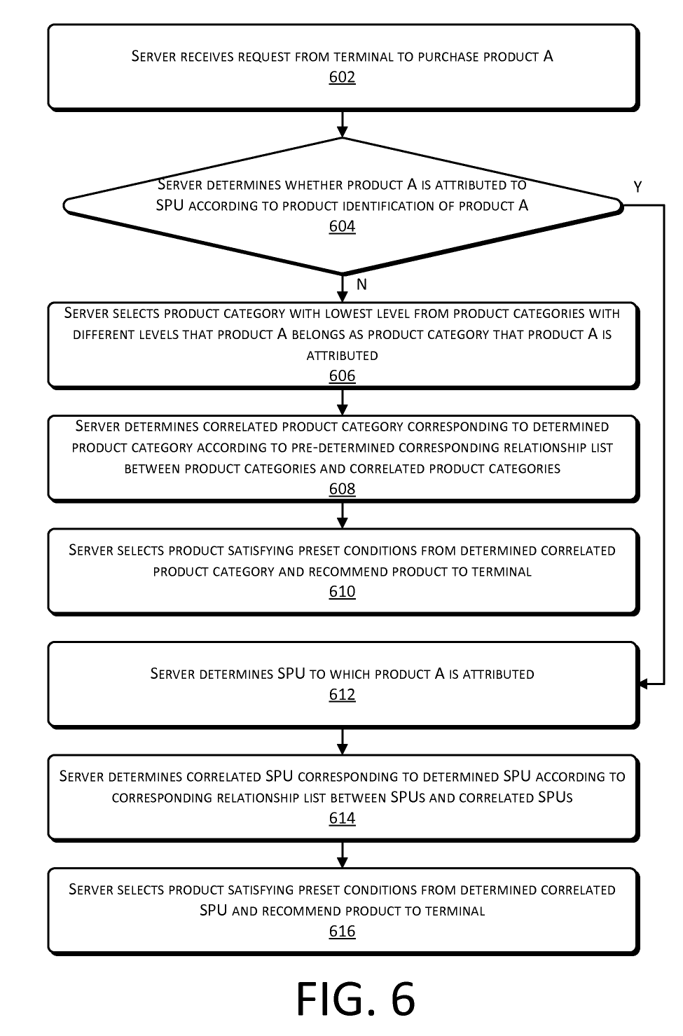

For example, the present disclosure below provides a detailed description by using a product A among products provided by the shopping website including multiple shops. FIG. 6 illustrates a flow chart of an example method for recommending a product in accordance with the second example embodiment of the present disclosure.

At 602, the server receives a request from the terminal to purchase the product A.

The server's received request may be an operation request from the terminal to purchase the product A. Alternatively, the server's received request may be an operation request from the terminal to place the product A into a shopping cart. Alternatively, the request may be an operation request to save the product A. The request may be defined according to an actual application scenario and the product characteristic. In addition, the request submitted by the terminal may include a product identification of the product A.

At 604, the server, according to the product identification of the product A, determines whether the product A belongs to a SPU. If a result of the determining is negative, operations at 606 are performed. If the result of the determining is positive, operations at 612 are performed.

At 606, the server selects a product category with a lowest level from product categories with different levels that the product A belongs as a product category that the product A is attributed. For example, the product category that the product A is attributed may be referred to as catA.

At 608, the server determines one or more correlated product categories corresponding to the determined product category according to a pre-determined corresponding relationship list between product categories and correlated product categories.

There may be one or multiple correlated product categories. For example, the determined correlated product categories may be stored in a correlated product category list. The correlated product categories of the product category catA may be stored in a preset correlated product category list referred to as catlist. In addition, the corresponding relationship list between the product categories and the correlated product categories may be pre-determined by the server according to a preset method. For example, the server may periodically update the corresponding relationship list according to a set time period. During updating, after the server determines the degrees of support of the product categories, the server, according to the degrees of confidence between the product categories, determines the product categories whose degrees of confidence satisfy a preset condition as the correlated product categories corresponding to the determined product category. In addition, for example, the correlated SPU corresponding to the determined product category may also be determined.

At 610, the server selects a product satisfying one or more preset conditions from the determined correlated product category, and recommends the product to the terminal.

The product satisfying the one or more preset conditions may be a product that is popular among users at terminals, a product that has a highest number of purchases among the users at the terminals, a product that has a highest relativity degree based on the operations of the user at the terminal, or a most recently promoted product by a shop. The one or more preset conditions may be flexibly set according to the actual scenarios.

At 612, the server determines the SPU to which the product A is attributed.

In the actual applications, the server may determine sets to which the products are attributed for multiple products at the same time. For the convenience of processing data, the SPU to which the product is attributed may be determined as spuA.

At 614, the server, from the corresponding relationship list between SPUs and correlated SPUs, determines one or more correlated SPUs corresponding to the determined SPU.

There may be one or multiple determined correlated SPUs. For example, the correlated SPU may be stored in the correlated SPU list, such as a preset SPU list referred to as spulist. For another example, in the actual applications, the server, in addition to determining the correlated SPUs corresponding to the SPU, may also determine the correlated product categories corresponding to the SPU.

At 616, the server selects a product satisfying one or more preset conditions from the determined SPUs and recommends the product to the terminal. The detailed operations at 616 may use the operations at 610 as a reference, and are not detailed herein.

In the flow process as shown in FIG. 6, no matter whether the determined set to which the product is attributed is the SPU or the product category, the determined SPU or product category includes other products that have the same attributes or characteristics as the product A at the designated shopping website, i.e., products having the same attributes or characteristics at various shops. In addition, according to the determined SPU or product category, the products in the correlated SPU or product category are also determined, which are products haing the same attributes or characteristics as the product A at the various shops. That is, the products selected by the user from the correlated SPU or product category may be products from different shops, thereby reducing a failure that the product recommended by the server to be presented at the terminal and a waste of processing resource. In addition, the set to which the product A is attributed is used to determine the correlated objects, thereby reducing a data volume processed by the server and improving a processing efficiency that the server pushes the business object.

In addition, in the flow process as shown in FIG. 6, after the server determines the SPU to which the product A is attributed, if the server fails to determine the correlated SPU corresponding to the SPU from the corresponding relationship list between the SPUs and the correlated SPUs, the server further selects a product category with a lowest level from the multiple product categories that the product A belongs as the product category that the product A is attributed and determines whether there is the correlated product category corresponding to the determined product category from the corresponding relationship list between the product categories and the correlated product categories. If there does not exist such product category with the lowest level, the server further selects a product category with a higher level from the multiple product categories to which product A belongs as the product category that the product A is attributed and determines whether there is the correlated product category corresponding to the product category with the higher level. Such operations are continuously performed until the product category having the corresponding correlated product category is selected from the multiple product categories the product A belongs.

Similarly, at 608, when the server determines the correlated product category corresponding to the determined product category according to the corresponding relationship list between the product categories and the correlated product categories, if there exists similar situations as shown above, similar processing may be implemented, which is not detailed herein.

In the actual applications, the present techniques may also be applicable in various forums and some other websites that provide service objects. Their detailed implementations are not described herein for the purpose of brevity.

A third example embodiment of the present disclosure provides an example apparatus for pushing the business object corresponding to the example method for pushing the business object as described in the first example embodiment. The apparatus is applicable in the e-commerce platform. By applying the presenting techniques at the e-commerce platform, the failure that the server pushes the business object to the terminal is reduced. Thus, the wasting of processing resource is reduced and the processing efficiency of pushing the business object is improved.

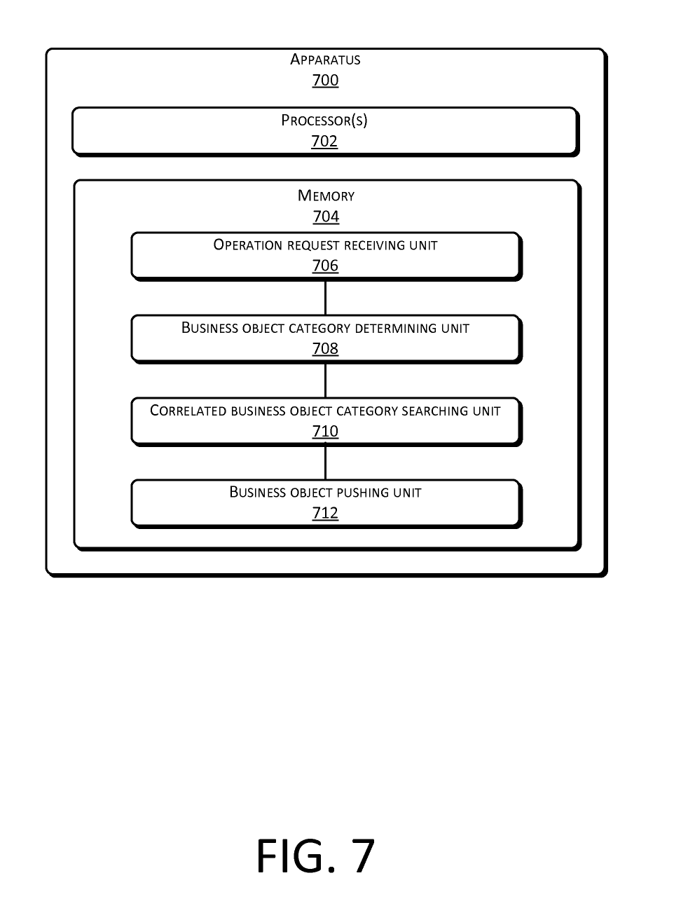

FIG. 7 shows a diagram of an example apparatus 700 for pushing the business object in accordance with the third example embodiment of the present disclosure. The apparatus 700 may include one or more processor(s) 702 and memory 704. The memory 704 is an example of computer-readable media. As used herein, “computer-readable media” includes computer storage media and communication media.

Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 704 may store therein program units or modules and program data.

In the example of FIG. 7, the memory 704 may store therein an operation request receiving unit 706, a business object category determining unit 708, a correlated business object category searching unit 710, and a business object pushing unit 712.

The operation request receiving unit 706 receives a business operation request from a terminal. The business operation request includes an object identification of a business object published at a website.

The business object category determining unit 708 determines a business object category of the business object corresponding to the object identification included in the business operation request received by the operation request receiving unit 706. Same business objects published by different business object providing units belong to a same business object category.

The correlated business category searching unit 710 searches, from a corresponding relationship list between business object categories and correlated business object categories, a correlated business object category corresponding to the business object category that is determined by the business object category determining unit 708. The correlated business object category is a business object category satisfying one or more preset correlation conditions with the determined business object category.

The business object pushing unit 712 selects a business object from the correlated business object category searched by the correlated business category searching unit 710 and pushes the business object to the terminal.

For example, the business object category determining unit 708 may, before determining the business object category corresponding to the business object indicated by the object identification, determines whether the business object identified by the object identification has a corresponding standard business object set. The standard business object set includes business objects satisfying one or more designated business object standards from the business object category.

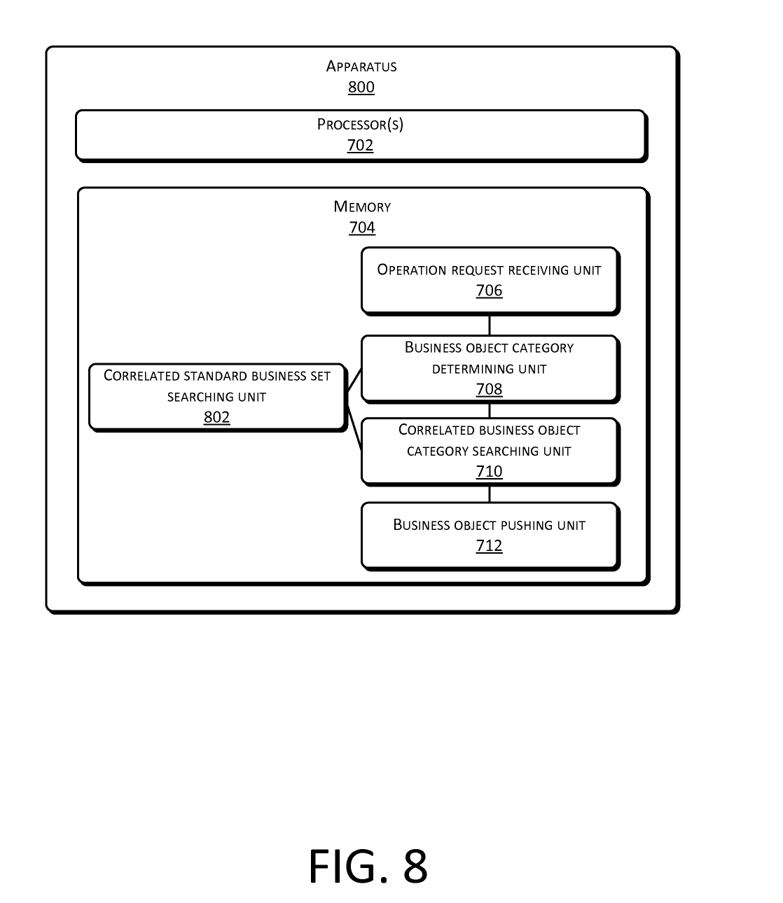

FIG. 8 illustrates a diagram of another example apparatus 800 for pushing the business object in accordance with the third example embodiment of the present disclosure. Based on the apparatus 700 as shown in FIG. 7, the apparatus 800 further includes a correlated standard business object set searching unit 802. When the business object category determining unit 710 determines the standard business object set that the business object indicated by the object identification is attributed, the correlated standard business object searching unit 802 searches a correlated standard business object set corresponding to the determined standard business object set according to a corresponding relationship list between standard business object sets and correlated standard business object sets. The correlated standard business object set is a set of business objects satisfying one or more preset correlation conditions with the determined standard business object set.

The business object pushing unit 712 selects a business object from the correlated standard business object set searched by the standard business object set searching unit 802 and pushes the business object to the terminal.

For another example, before the business object is selected from the searched correlated business object category, if the correlated business object category searching unit 710 fails to find the correlated business object category corresponding to the determined business object category in accordance with the corresponding relationship list between business object categories and correlated business object categories, the business object category determining unit 708 determines a business object category having a level higher than the previously determined business object category from the business object categories with different levels that the business object indicated by the object identification belongs.

The correlated business object category searching unit 710 searches the correlated business object category corresponding to the determined business object category whose level is higher than the previously determined business object category in accordance with the corresponding relationship list between the business object categories and the correlated business object categories.

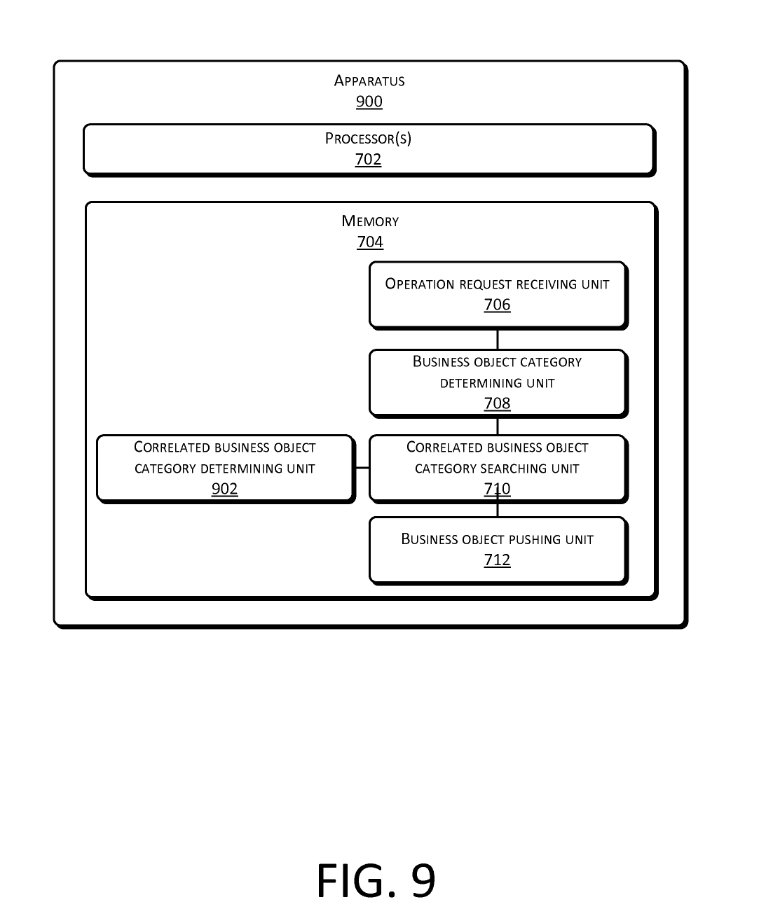

FIG. 9 illustrates a diagram of another example apparatus 900 for pushing the business object in accordance with the third example embodiment of the present disclosure. Based on the apparatus 700 as shown in FIG. 7, the apparatus 900 further includes a correlated business object category determining unit 902 that, before the correlated business object category searching unit 710 searches the correlated business object category corresponding to the determined business object category, performs the following operations to determine the correlated business object categories of the business object categories.

Based on statistics from records that the business objects published at the website that are operated by the same terminal for a designated operation, a number of times that a business object in the designated business object category and another business object in some other business object categories are operated by the same terminal is determined.

From the same other business object categories, the business object category whose number of times satisfying a preset number of times is determined as the correlated business object category corresponding to the designated business object category.

For example, the units in the above example apparatuses may be hardware or just logically classified according to their functionalities. In the actual applications, the above units may be integrated or segmented. In addition, the functionalities provided by the units may correspond to the flow process of the example method embodiments that push the business object. Thus, the more detailed processing implemented by the example apparatuses may be already described by the example methods in detail. The relevant portions in the example apparatus embodiments may be referenced to the corresponding portions in the example method embodiments, the details of which are not detailed herein for the purpose of brevity.

In addition, the example apparatuses of the third example embodiment also have functional modules to implement the techniques as described in the first and second example embodiments, the details of which are not detailed herein for the purpose of brevity.

One of ordinary skill in the art should understand that the embodiments of the present disclosure can be methods, systems, apparatuses (devices), or the programming products of computers. Therefore, the present disclosure can be implemented by hardware, software, or in combination of both. In addition, the present disclosure can be in a form of one or more computer programs containing the computer-executed codes or instructions which can be included or stored in the computer storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer-executed instructions. These computer-executed instructions can be provided to the general computers, specific computers, embedded processor or any other programmable data devices including one or more processors to generate a machine, so that a device of implementing one or more flows of the flow chart and/or one or more blocks of the block diagram can be generated through the instructions operated by a computer or other programmable data processors.

The computer-executed instructions may also be stored in one or more computer storage media that cause the computer or any other programmable data processing devices to work in a specific way so that the computer-executed instruction stored in the computer storage media may form a product including a computer-executed instruction apparatus. The computer-executed instruction apparatus is capable to implement functionalities designated by one or more flows and/or blocks of the flowcharts and/or block diagrams.

The computer-executed instructions may also be loaded into the computer or any other programmable data processing devices to cause the computer or any other programmable data processing devices to perform a series of operations to implement computer processing. Thus, the computer-executed instruction performed at the computer or any other programmable data processing devices implements implement functionalities designated by one or more flows and/or blocks of the flowcharts and/or block diagrams.

It is noted that any relational terms such as “first” and “second” in this document are only meant to distinguish one entity from another entity or one operation from another operation, but not necessarily request or imply existence of any real-world relationship or ordering between these entities or operations. Moreover, it is intended that terms such as “include”, “have” or any other variants mean non-exclusively “comprising”. Therefore, processes, methods, articles or devices which individually include a collection of features may not only be including those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

The above descriptions illustrate example embodiments of the present disclosure. One of ordinary skill in the art may make modifications or changes to the example embodiments after obtaining basic concepts of the present disclosure. Thus, the claims of the present disclosure shall be interpreted to include the example embodiments described herein and any modification or changes within the scope of the present disclosure. The embodiments are merely for illustrating the example embodiments and are not intended to limit the scope of the present disclosure. It should be understood by one of ordinary skill in the art that certain modifications, replacements, and improvements can be made and should be considered under the protection of the present disclosure without departing from the principles of the present disclosure. If such modifications, replacements, and improvements fall into the scope of the claims of the present disclosure or equivalent techniques of the claims of the present disclosure, such modifications, replacements, and improvements shall be included in the present disclosure.

What is claimed is:

1. A method comprising:
receiving a business operation request, the business operation request including an object identification of a business object published or provided at a website;
determining a business object category of a business object corresponding to the object identification; and
searching a correlated business object category corresponding to the determined business object category according to a corresponding relationship list between business object categories and correlated business object categories.

2. The method as recited in claim 1, further comprising:
selecting another business object from the searched correlated business object category; and
pushing the another business object to a terminal.

3. The method as recited in claim 1, wherein same business objects published or provided by different business object providing units at the website belong to a same business object category.

4. The method as recited in claim 1, wherein the correlated business object category is another business object category that satisfies one or more preset correlated conditions with the determined business object category.

5. The method as recited in claim 1, wherein the corresponding relationship list between the business object categories and the correlated business object categories is pre-set by a server.

6. The method as recited in claim 1, further comprising prior to the determining the business object category of the business object corresponding to the object identification, determining whether the business object corresponding to the object identification belongs to a standard business object set, the standard business object set including one or more business objects satisfying one or more standard object standards within a respective business object category.

7. The method as recited in claim 6, further comprising:
after determining that the business object corresponding to the object identification belongs to the standard business object set, searching a correlated standard business object set corresponding to the determined standard business object set according to a corresponding relationship list between standard business object sets and correlated standard business object sets;
selecting another business object from the searched correlated standard business object set; and
pushing the another business object to a terminal.

8. The method as recited in claim 6, wherein the standard business object set has a designated naming specification and a designated function for business objects included in the standard business object set.

9. The method as recited in claim 1, wherein the determined business object category is a business object category with a lowest level among various business object categories with different levels that the business object corresponding to the object identification belongs.

10. The method as recited in claim 9, further comprising:
when the correlated business object category corresponding to the determined business object category is not found according to the corresponding relationship list between the business object categories and the correlated business object categories, determining another business object category whose level is higher than the determined business object category from various business object categories with different levels to which the business object corresponding to the object identification belongs; and
searching the correlated business object category corresponding to the another business object category according to the corresponding relationship list between the business object categories and the correlated business object categories.

11. The method as recited in claim 1, further comprising establishing the corresponding relationship list between the business object categories and the correlated business object categories, the establishing including:
based on statistics from records that the business objects published at the website that are operated by a terminal for a designated operation, determining a number of times that a respective business object in a designated business object category and another business object in some other business object categories are operated by the terminal; and
from some other business object categories, determining a respective business object category whose number of times satisfying a preset number of times as a correlated business object category corresponding to the designated business object category.

12. A method comprising:
receiving a request for a product, the request including a product identification;
determining whether the product is attributed to a standard product unit according to the product identification of the product;
in response to determining that the product is not attributed to a standard product unit according to the product identification of the product, selecting a product category with a lowest level from various product categories with different levels that the product belongs as a product category that the product is attributed;
determining a correlated product category corresponding to the selected product category; and
selecting a particular product satisfying one or more preset conditions from the determined correlated product category.

13. The method as recited in claim 12, further comprising recommending the particular product to a terminal.

14. The method as recited in claim 12, further comprising:
in response to determining that the product is attributed to a standard product unit according to the product identification of the product,
determining a correlated standard product unit corresponding to the standard product unit; and
selecting a particular product satisfying one or more preset conditions from the determined correlated standard product unit.

15. The method as recited in claim 14, further comprising recommending the particular product to a terminal.

16. The method as recited in claim 12, wherein the standard product unit has a designated naming specification and a designated function for products included in the standard product unit.

17. An apparatus comprising:
an operation request receiving unit that receives a business operation request from a terminal, the business operation request including an object identification of a business object published or provided at a website;
a business object category determining unit that determines a business object category of the business object corresponding to the object identification included in the business operation request received by the operation request receiving unit, same business objects published or provided by different business object providing units belonging to a same business object category;
a correlated business category searching unit that searches, from a corresponding relationship list between business object categories and correlated business object categories, a correlated business object category corresponding to the business object category that is determined by the business object category determining unit, the correlated business object category being a business object category satisfying one or more preset correlation conditions with the determined business object category; and
a business object pushing unit that selects a particular business object from the correlated business object category searched by the correlated business category searching unit and pushes the particular business object to the terminal.

18. The apparatus as recited in claim 17, further comprising a correlated standard business object set searching unit that, when the business object category determining unit determines a standard business object set to which the business object indicated by the object identification is attributed, searches a correlated standard business object set corresponding to the determined standard business object set according to a corresponding relationship list between standard business object sets and correlated standard business object sets.

19. The apparatus as recited in claim 18, wherein the correlated standard business object set is a set of business objects satisfying one or more preset correlation conditions with the determined standard business object set.

20. The apparatus as recited in claim 17, further comprising a correlated business object category determining unit that, before the correlated business object category searching unit searches the correlated business object category corresponding to the determined business object category, determines the corresponding relationship list between the standard business object sets and the correlated standard business object sets.
